(19) United States
(12) Patent Application Publication
(10) Pub. No.: US 2010/0331220 A1
(43) Pub. Date: Dec. 30, 2010

(54) ACOUSTIC DEVICE

(76) Inventors: Pramukh Nalaka Jayasekera, Wiltshire (GB); Jeremy John Hawkes, Manchester (GB); Rito Mijarez-Castro, Morelos (MX)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/863,200

(22) PCT Filed: Jan. 19, 2009
(86) PCT No.: PCT/GB09/00129

§ 371 Date: Sep. 10, 2010

(30) Foreign Application Priority Data
Jan. 17, 2008 (GB) 0800798.1

(51) Int. Cl. C40B 60/14

(52) U.S. Cl. 506/40

(57) ABSTRACT

There is disclosed an acoustic device for manipulation of fluid samples including fluid samples comprising particles characterised in that it comprises a flexible member, a sound wave generator for generating a sound wave and a sound wave coupler for coupling the sound wave from the generator into the flexible member, in which the device, flexible member and the coupler are adapted to excite a predetermined acoustic mode of pure resonant vibration in the flexible member at a predetermined frequency of the sound wave.

The present invention is directed to an acoustic device for manipulating fluid samples and fluid samples containing particles. It is particularly, although not exclusively, concerned with an acoustic device providing ninety-six or more acoustic potential wells that enables high throughput handling of cell samples therein.

Modern analytical methods are increasingly characterised by a requirement for screening of large compound libraries. Traditional planar (two dimensional) arrays are ideal for this purpose, but are often accompanied by problems associated with mixing of liquid samples.

The mixing of samples by diffusion in the standard ninety-six reaction well plate used for these methods can be time consuming—especially where agglutination of reactants is relied upon. Whilst mechanical mixing of such samples is possible, it is not practicable for higher density well plates because of the very small volumes of samples which must be employed.

It is well-known to use ultrasound for mixing of liquids and for filtration of particles from liquid samples. Many prior art devices rely upon direct generation of a standing sound wave within a liquid sample and describe the manipulation of particles in or between liquids (see, for example, Applicant's international patent application WO 2004/024287 A1).

Although these devices do permit positioning of particles at one or more acoustic pressure nodes within a liquid stream they do not permit screening because they do not enable treatment of different particle clusters with different reactants or with different concentration of the same reactant.

In addition, many of these prior art devices cannot filter particles from large volumes of water without high power consumption and runaway heating.

The present invention generally aims to overcome these problems by providing for indirect generation of a standing sound wave in a fluid sample.

It is well-known that fixed membranes and flexible plates vibrate at certain natural frequencies producing a standing wave and that each standing wave or “resonance mode” is characterised by one or more nodal lines at which there is no movement of the membrane or plate at all.

This phenomenon is most easily seen in the accumulation of dry particles on the vibrating surface of a membrane or plate to form often quite complex patterns known as Chladni figures.

In circular plates, the displacement (or velocity) nodal lines are observed to be concentric or diametric whilst for rectangular plates the nodal lines are parallel to the longitudinal or lateral edges of the major surface of the plate.

For an ideal rectangular plate of uniform density the nodal lines define a grid of equally sized cells.

The behaviour of particles and liquids within three dimensional acoustic devices such as that mentioned above has been the subject of much study.

The forces which lead to clumping of particles at one or more pressure nodes are considered to comprise three distinct types, namely direct acoustic forces, lateral forces arising within the device which act orthogonally to the direction of sound wave and scattering forces arising from interaction between particles and from fluid streaming (acoustic streaming) driven by the vibration of the plate.

The studies, however, are mostly concerned with the magnitude of these forces and to Applicant's knowledge only one study (Whitworth, G. and Coakley, W. T., J. Acoust. Soc. Am. 1992, 91, 79-85) is actually directed to the deliberate positioning of particle clumps and then not as an array but as a single, centralised clump.

It has now found that certain acoustic devices comprising a vibrating plate can provide for reliable positioning of particles and/or liquids in well-defined arrays.

Accordingly, in a first aspect, the present invention provides an acoustic device for manipulation of fluid samples and/or particles in fluid samples, characterised in that it comprises a flexible member, a sound wave generator for generating a sound wave and a sound wave coupler for coupling the sound wave from the generator into the flexible member, in which the device, the flexible member and the coupler are adapted to excite a predetermined acoustic mode of pure resonant vibration of the flexible plate at a predetermined frequency of the sound wave.

As used herein, the expression “acoustic mode of pure resonant vibration” refers to a single, resonant mode of flexural vibration of the flexible member which mode is substantially free from destructive interference by any other standing sound wave, in particular, a standing sound wave arising from any other part of the device.

It will be appreciated, therefore, that the present invention provides a device which isolates a single mode of acoustic vibration of a flexible member that directs acoustic streaming of fluids in a controlled manner.

It will be understood, in particular, that the flexible member and the sound wave coupler are adapted to produce that single mode and that the predetermined frequency of the sound wave corresponds to one or other natural frequency of vibration of the flexible member which results in a standing wave defining a desired number of acoustic potential wells therewith.

The sound coupler may be adapted to produce the predetermined acoustic mode of vibration at the predetermined frequency by focusing of the sound wave produced by the generator at a predetermined position on the flexible member.

The predetermined position preferably, but not essentially, corresponds to the exact position of a displacement anti-node (and not a node) of the predetermined acoustic mode of vibration of the flexible member.

In a preferred embodiment, the sound coupler comprises a stepped sound horn or wedge transducer which is mechanically coupled at the predetermined position to the flexible member by a screw coupling, gluing or welding.

The flexible member may be adapted to produce the predetermined acoustic mode of vibration at the predetermined frequency by choice of suitable material and parameters. The flexible member may, in particular, comprise a flexible plate of suitable material and dimension or a fixed, elastic membrane of suitable dimension and tensioning.

The material of the flexible plate must support its flexural vibration and will generally comprise a “hard” material such as glass, plastics or metal, for example, aluminium of uniform density. The plate may, in particular, comprise a laminate of a thin layer of paint provided to an aluminium plate or a thin layer of gold or platinum provided to a base metal plate.

It is preferred that the plate is durable and that the metal is resistant to corrosion or other oxidation—especially where fluid thicknesses on the plate are intended to be less than about 10 mm.

The flexible plate may be transparent whereby to facilitate interrogation of reaction events thereon by the conventional optical, plate readers often used for transparent standard reaction well plates.

In a preferred embodiment, a flexible plate has length and width substantially similar to that of the standard ninety-six reaction well plate for high throughput screening methods (i.e. length 105 mm×width 70 mm).

In this embodiment, therefore, the flexible plate is adapted to produce the predetermined acoustic mode of vibration at the predetermined frequency merely by choice of the appropriate thickness.

The choice need not, however, be a matter of trail and error, but can be determined by computer software for three dimensional mechanical modelling of structures by finite element analysis by such as Abaqus 6.5.1 (commercially available from Simulia, USA) and/or computer software for two dimensional analysis of sound waves generated in plates or cylindrical structures of infinite length such as Disperse (version 2.0.16b; available on request from M. Lowe at Dept. Mechanical Engineering, Imperial College, London, UK).

The predetermined frequency of the sound wave set by the generator, which may comprise a piezoelectric material, is conveniently between about 40 kHz and about 10 MHz and preferably between about 40 kHz and about 3 MHz.

For samples comprising water, the predetermined frequency will be between about 1 MHz and about 10 MHz so as to avoid cavitation which can disrupt controlled acoustic streaming.

The power of the sound wave is not particularly important—but will generally be less than 100 W in order to protect the samples from overheating. The power may, in particular, be between about 0.1 W and about 10 W and is preferably about 5 W or less.

In a preferred embodiment, therefore, the flexible plate has length 105 mm, width 70 mm and thickness between about 1 mm to about 100 mm depending on its material.

The acoustic device may be adapted to isolate the predetermined acoustic mode of vibration at the predetermined frequency by design minimising the effect of structural features of the device, such as side walls, which give rise to lateral streaming within the fluid sample.

In one embodiment (the “open structure”) the device simply comprises a suitable flexible plate which is mechanically coupled to the sound coupler by a grub screw, gluing or welding as mentioned above.

In another embodiment (the “closed structure”) the device further comprises a reflector plate provided opposite the flexible plate at a separation distance there between which is equivalent to about an integer number multiple of about a half of the wavelength of the sound wave in the fluid sample.

Typically, the separation distance is between about 0.07 mm and about 5.00 mm depending on the fluid sample and the predetermined frequency. For samples comprising water, the separation distance will be about 0.75 mm or less at frequencies between about 1 MHz and about 1.0 MHz whilst for samples comprising air the separation distance may be between about 4.00 mm and about 0.16 mm for frequencies between about 40 kHz and about 1 MHz.

Of course, the thickness of the reflector plate is about an integer multiple of a quarter of the wavelength of the sound in therein. For example, the thickness of a glass (Pyrex®) reflector plate is about 35 mm for a predetermined frequency of about 40 kHz.

The closed device may comprise a chamber in which opposed flexible plate and reflector plate are separated by side walls. In that case, the chamber preferably has an aspect ratio of about 100 and/or its side walls comprise a sound absorbent material such as rubber and/or are shaped whereby to reduce lateral modes of standing wave vibration.

In any case, the device may also comprise a micrometer or similar means for adjusting the separation distance between about 0.01 mm and about 5.00 mm.

It will be appreciated that the shape of the flexible plate (and the reflector plate) is not generally limited but will be dictated by the shape of the predetermined acoustic mode and, in particular, the desired number of acoustic potential wells.

In preferred embodiments, the flexible plate is rectangular in shape and the predetermined acoustic mode defines a plurality of acoustic potential wells, preferably between four (4) and one thousand five hundred and thirty six (1536) acoustic wells, for example, three hundred and twenty (320) or ninety-six (96) acoustic potential wells.

The device may further comprise means for introducing various substrates and reagent solutions to the flexible plate.

In the open structure, the device may additionally comprise an automated array of dispensers for dispensing reagent solutions at different concentrations to different positions on the flexible plate.

In the closed structure, a more complex arrangement is required—which provides for introduction of reagent solutions to the flexible plate without disruption of the predetermined acoustic mode.

International patent application number WO 02/25269 A1 describes a pumping arrangement for laminar flow of ten adjacent streams of particle suspensions across a chamber.

In one embodiment, the device comprises a hollow skirting plate in which the flexible plate is sealed by a rubber gasket. The skirting plate is provided with one or more inlet ports and one or more outlet ports. The inlet and outlet ports are associated with a pumping arrangement for providing adjacent laminar flow of fluids over the flexible plate.

In this embodiment, a rectangular skirting plate may, in particular, define a circumferential array of circular inlet and outlet ports in which twelve inlet ports are located adjacent a longitudinal inside edge and eight inlet ports are located adjacent a lateral inside edge—with corresponding outlet ports similarly located adjacent the corresponding opposite inside edges.

In this embodiment, the device should include additional inlet and outlet ports for providing a flow of carrier fluid across the whole of the working surface of the plate—so as to prevent mixing of the laminar flows across the plate.

The additional ports may be provided at or adjacent the outside edges of the skirting plate and the pump arrangement is adapted to switch in supply of aqueous reagent solutions to the inside ports to a supply of aqueous substrate solution or carrier solution to the outside ports.

The pump arrangement may, in particular, provide for the passage of carrier liquid and reagent solutions across the plate at an average velocity of about 6 cm s⁻¹ or less.

In a second aspect, the present invention provides a flexible plate for use in the acoustic device according to the first aspect of the invention. Embodiments of the flexible plate will be apparent from the foregoing description.

The flexible plate may comprise any material supporting the predetermined acoustic mode of resonant, flexural vibration at the predetermined frequency. It may, in particular, comprise a plastics material, glass, aluminium of uniform density as described above. In a preferred embodiment, the flexible plate comprises a plastics material and is transparent.

The flexible plate may, in particular, comprise a transparent, rectangular plate of length and width substantially similar to the standard ninety-six reaction well plate (105 mm×70 mm) and thickness between about 1 mm and about 100 mm depending on its material.

In a third aspect, the present invention provides for use of a device according to its first aspect for the manipulation of fluid samples and particles therein. The manipulation may, in particular, be directed to sample mixing and/or particle clumping facilitating high throughput screening methods and/or filtration.

The use is not limited by any one type or size of particle—although particles of mean diameter between about 0.1 μm and about 500 μm are most suitable. Such particles may, in particular, comprise biological particles such as cells, viruses and spores.

In one embodiment, the use is directed to high throughput analytical methods and relies upon a closed structure device producing a predetermined acoustic mode in the flexible plate which defines ninety-six (96) acoustic potential wells therewith. This use may, in particular, be directed to screening of candidate antibiotics or synthesis of libraries of chemical and/or biological compounds.

In another embodiment, the use is directed to filtering fluids or to concentration of particles from a fluid stream and relies upon an open or closed structure device producing an acoustic mode in the flexible plate which defines one or more acoustic potential wells therein.

This use may, in particular, comprise scrubbing of air or other gases, purification of water or concentration of micro-organisms to levels suitable for their detection.

In another embodiment, the use relies on open or closed structure devices and is directed to fluid mixing, fluid pumping and/or heat exchange.

The device is particularly suited for high throughput analytical methods in that it provides for controlled and efficient mixing of particles and/or liquids with various reagent solutions in very small amounts in short time.

The device enables controlled positioning of biological cells within a structure without the need to provide an adherent for fixing them to a surface such as the standard ninety-six well plate.

The flexible member may, in particular, support an acoustic mode of one thousand five hundred and thirty six nodes so permitting very high throughput compared to the standard reaction well plate.

Further, the device avoids the need for disposable standard reaction well plates of the prior art in that it can comprise glass which can easily be cleaned. In addition, the glass plate is more transparent than the standard reaction well plate and so enables more reliable determination of reaction events thereon by optical detectors.

The device provides more efficient particle collection than prior art devices because the prior art devices rely on a transducer adhered across the whole face of the active chamber wall—which suppresses lateral modes of acoustic vibration.

Furthermore, because the flexible member is driven at its natural frequency, the device is more efficient for the filtration of large volumes of water as opposed to prior art devices. In particular, the device is not limited in size and can be driven at higher sound levels with less energy than prior art devices and so avoids the problem of runaway heating.

The device may be readily incorporated into existing particle filtration and/or collections systems.

The present invention, therefore, provides a versatile acoustic device which allows manifold uses involving manipulation of fluid samples and particles by a flexible member with control of node positioning and acoustic streaming.

The present invention is now described with reference to the following embodiments and the accompanying drawings in which

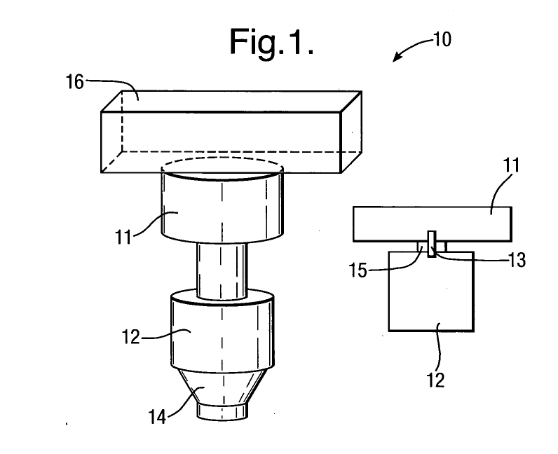

FIG. 1 is a schematic illustration including an exploded view showing a device according to several embodiments of the present invention;

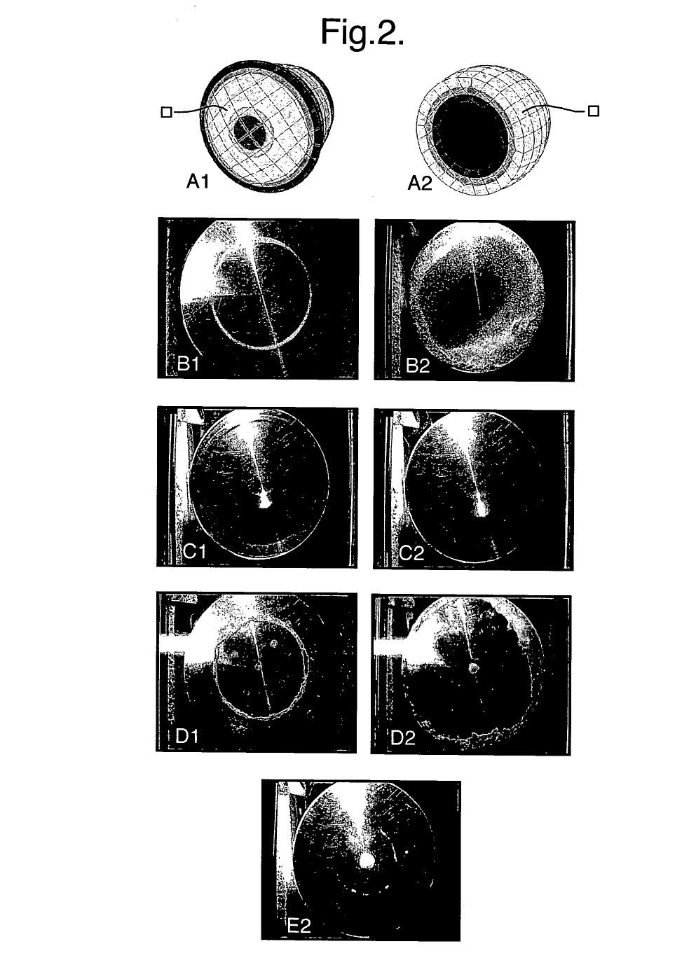

FIG. 2 comprises photographs showing clumping of particles and/or heaping of liquids in the embodiments of FIG. 1;

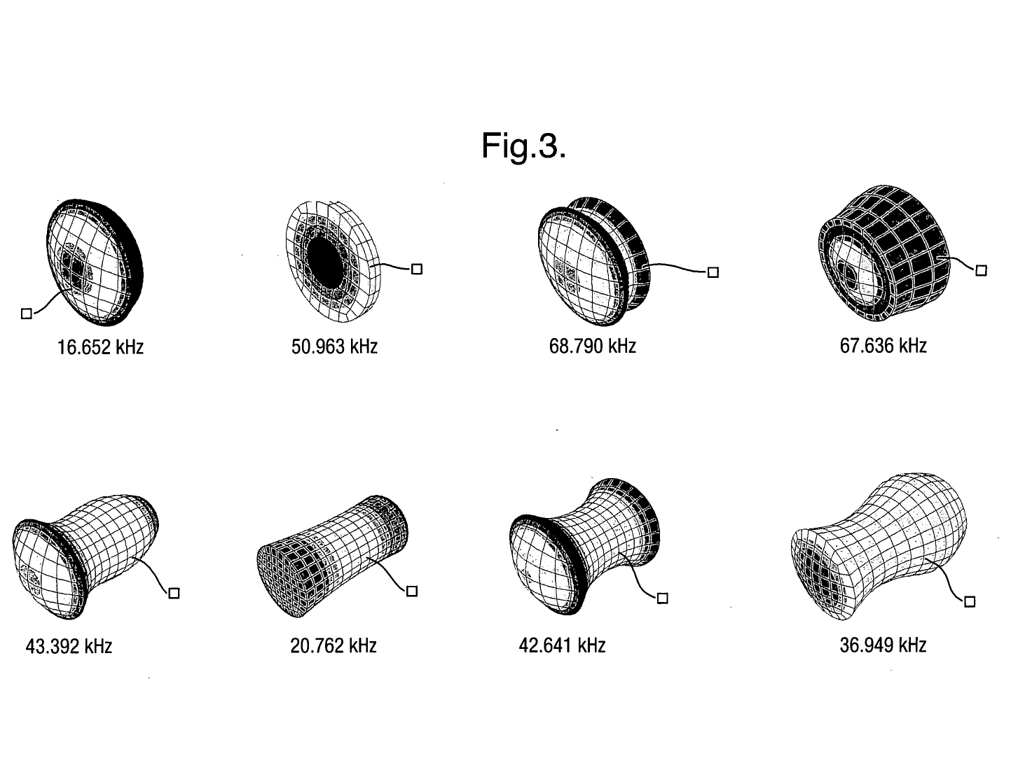

FIG. 3 shows three-dimensional graphs of acoustic modes A to D in two circular plates as determined by computer modelling studies;

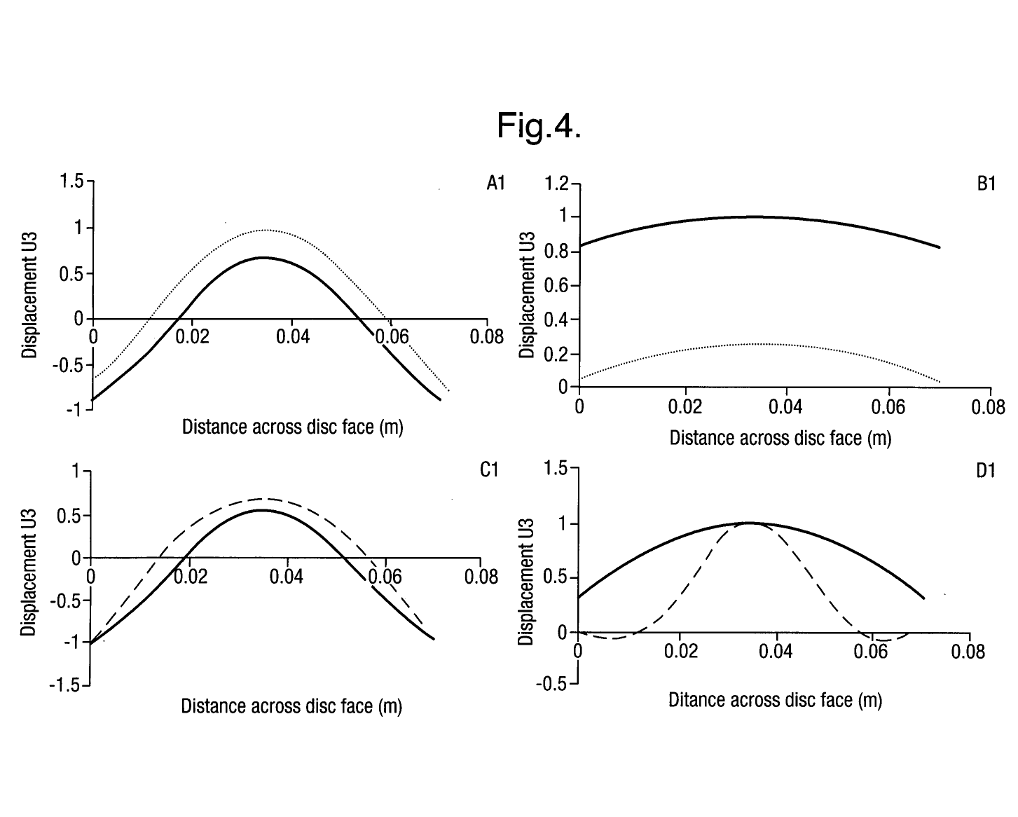

FIG. 4 shows graphs reporting the surface displacements of the circular plates in the acoustic modes shown in FIG. 3;

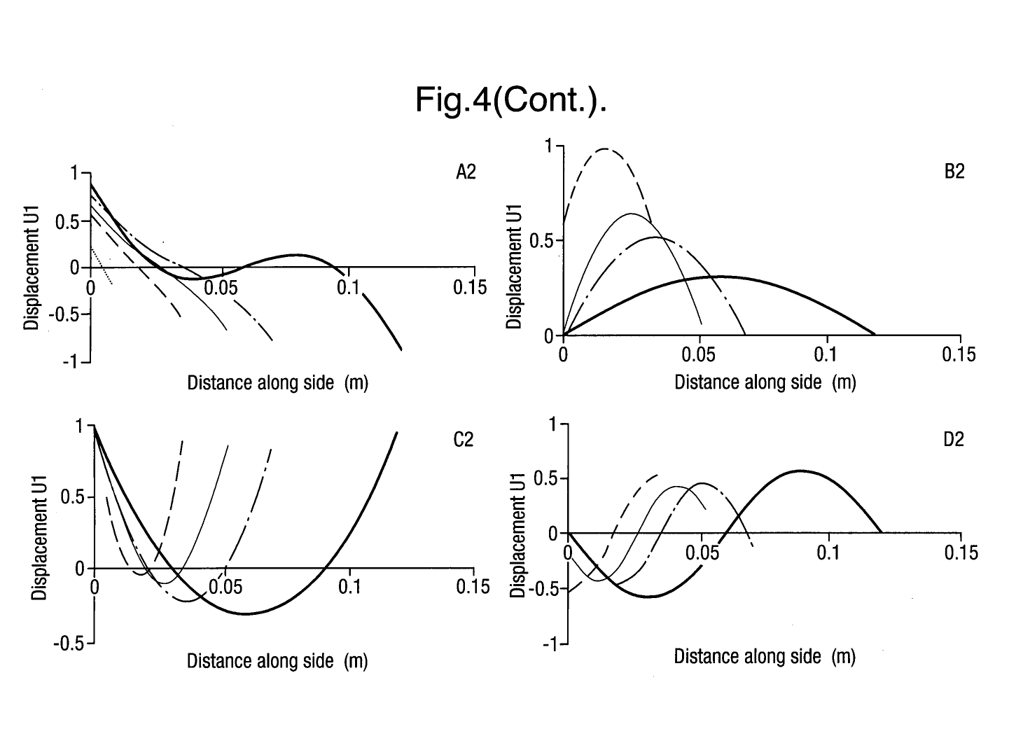

FIG. 5 is a graph showing acoustic mode frequencies A to D as determined by computer modelling for different thicknesses of circular discs;

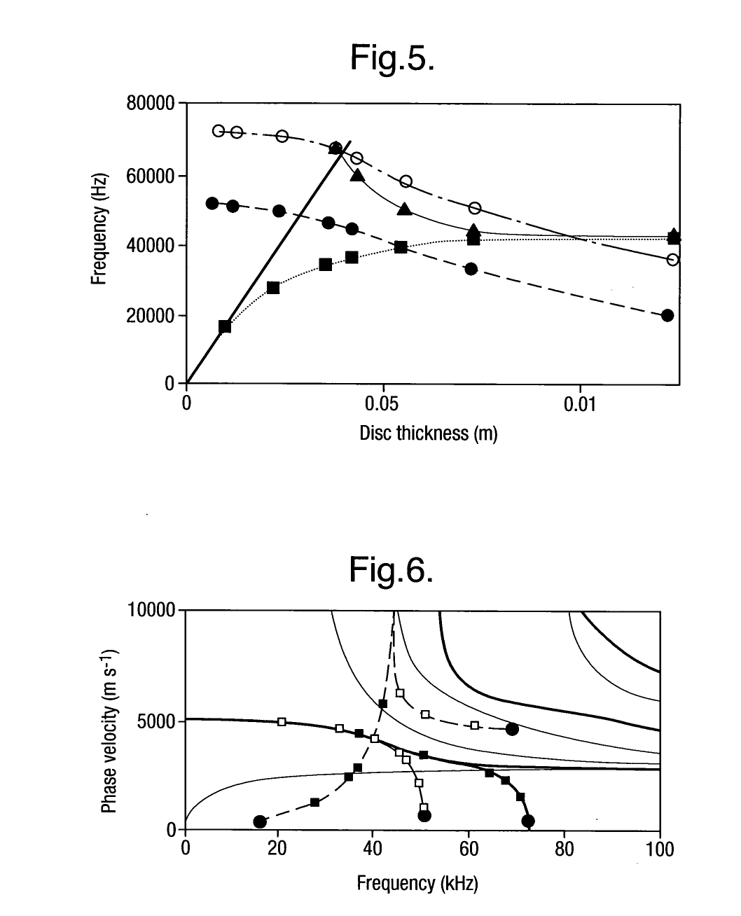

FIG. 6 is a graph showing phase velocities calculated for modes A to D compared to phase velocities predicted by a two dimensional computer model;

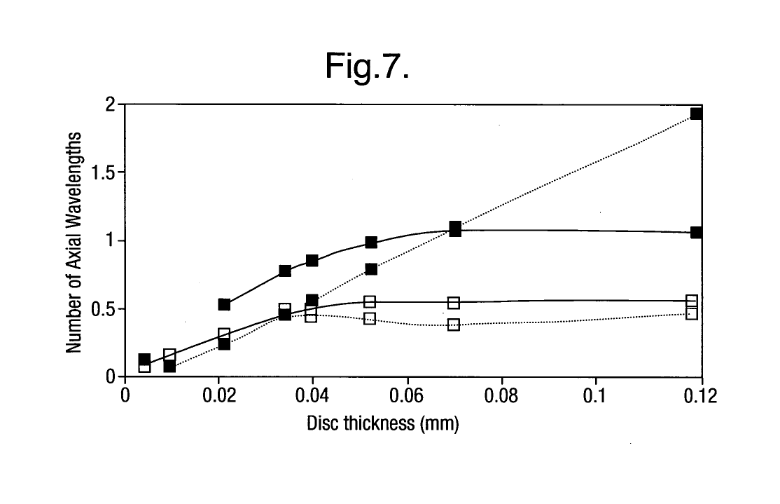

FIG. 7 is a graph showing the number of axial wavelengths in modes A to D for different thicknesses of circular discs;

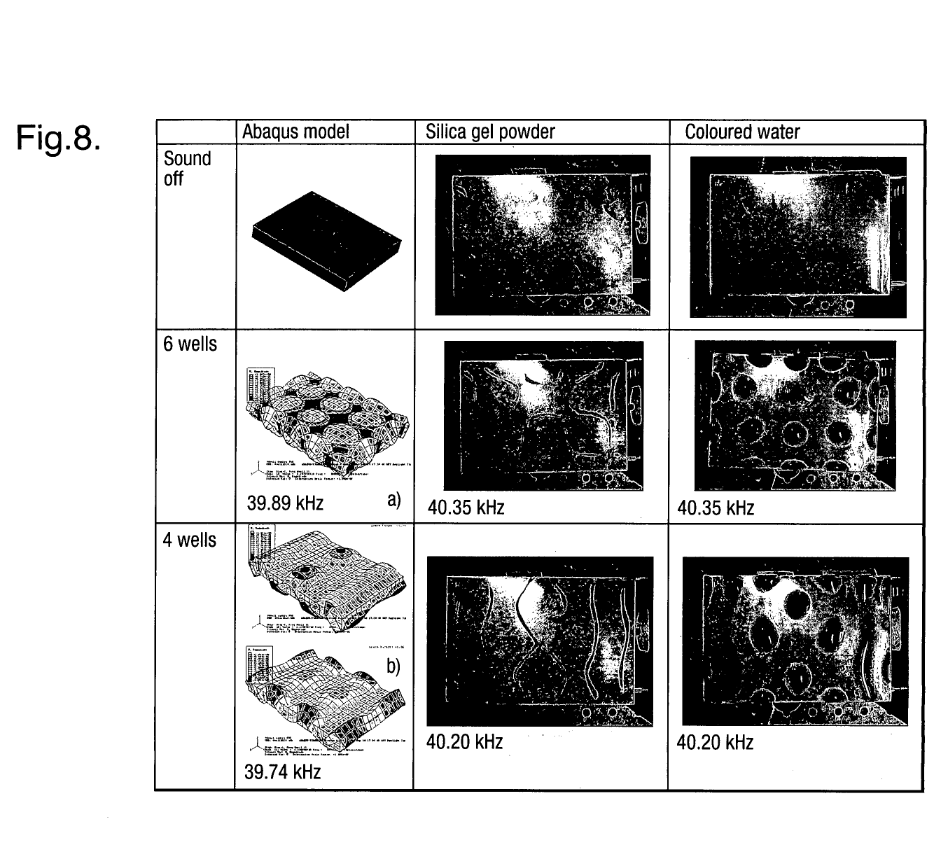

FIGS. 8 a) and b) are graphs and photographs showing calculated and actual modes of vibration in a rectangular aluminium plate;

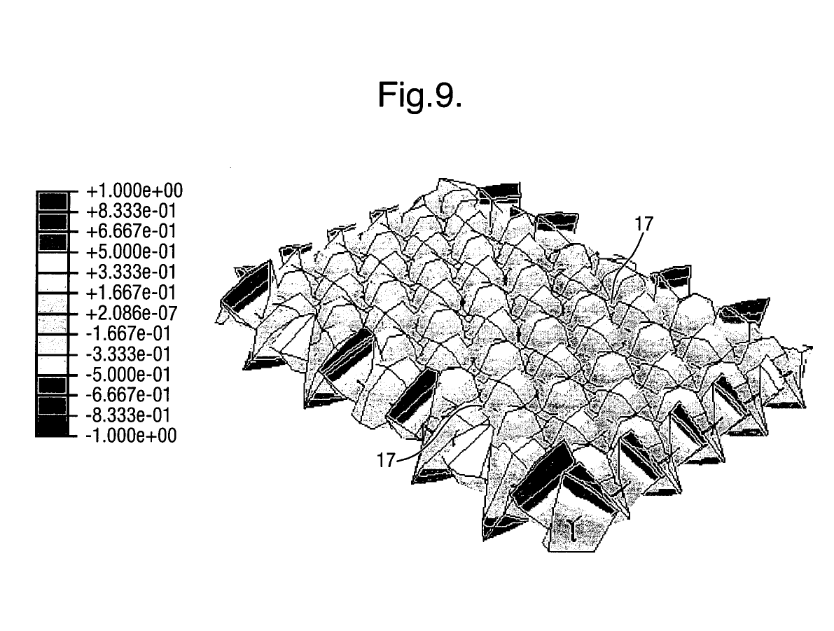

FIG. 9 is a three-dimensional graph showing an acoustic mode of vibration (12×8) in a rectangular aluminium plate as determined by computer modelling studies;

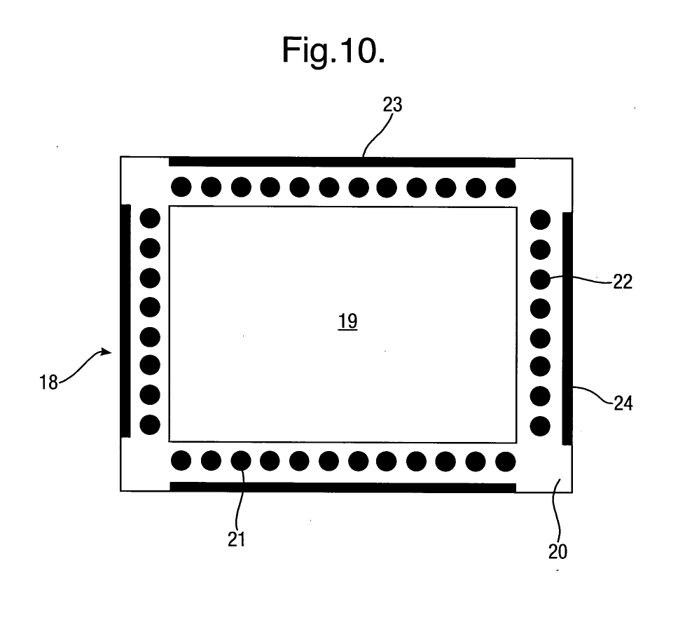

FIG. 10 is a plan view showing part of a device according to another embodiment present invention; and

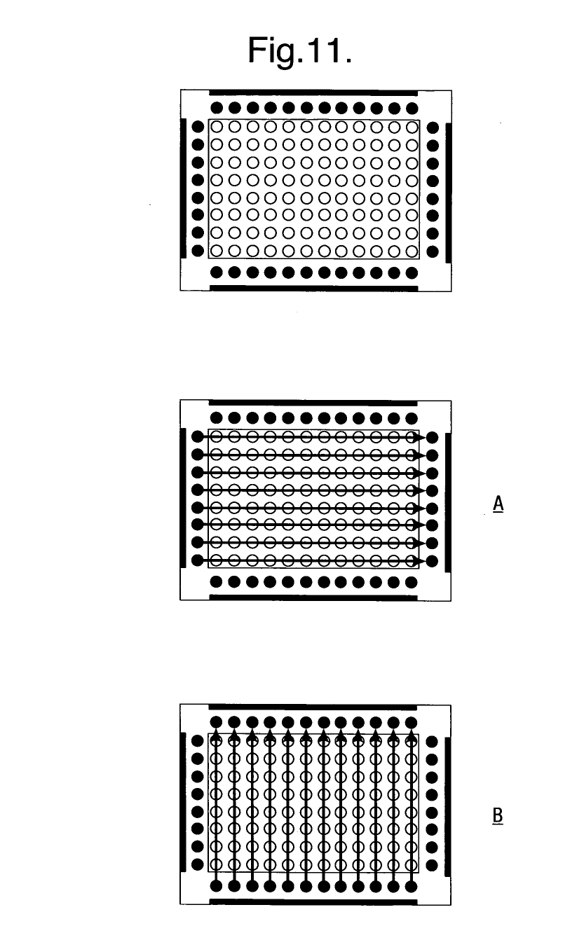

FIG. 11 is a scheme showing use of the embodiment of FIG. 10 for high throughput screening.

Referring now to FIG. 1, an acoustic device according to one embodiment of the present invention 10 (the open structure) comprises a circular aluminium disc 11 of diameter 70 mm and suitable thickness which is connected at its centre to an aluminium stepped horn 12 by a grub screw 13. The stepped horn 12 is in turn connected to a transducer 14 (40 kHz 50W Langevin type, Morgan Matroc P/N 0909) by a grub screw (not shown). A paper washer 15 is provided to minimise coupling of sound generated by the transducer 14 outside the connection region on the disc 11.

In a second embodiment (the closed structure) the device 10 includes a rectangular glass, reflector plate 16 of thickness 35 mm which is disposed opposite disc 11 at a distance of between about 0.1 mm and about 5 mm therefrom.

The transducer 14 is driven by a sine wave signal (˜50 Vₚ₋ₚ) amplified (240L ENI, Rochester, USA) from a function generator (33120A, Hewlett-Packard).

Suitable thicknesses of the aluminium disc may be determined by equation (1; R. D. Blevins in “Formulas for Natural Frequencies and Mode Shape” at page 240; Ed. Kreiger; Malabar 1979) or by computer modelling for the desired order of circular modes of acoustic vibration of the disc at a frequency of about 40 kHz.

Fᵢⱼ=λᵢⱼ²/2πa²×[Eh³/12γ(1−v²]^{1/2} (1)

where a is the radius of the disc, h is the thickness of the disc, i is diametric node number, j is circular node number not counting the boundary, λ is a dimensionless parameter function for mode of node numbers i and j, E is modulus of elasticity, p is density, γ is mass per unit area of the disc (which is μh) and v is Poisson's ratio.

### Validity of Modelling

The agreement between thicknesses of disc 11 predicated by equation (1) and computer modelling for desired modes at a frequency of about 40 kHz and actual modes determined by direct observation of Chladni figures for the open structure device was studied.

For the lowest mode of resonant vibration of a free plate (j=1) and the lowest mode of resonant vibration of a plate clamped at its centre (j=0), equation (1) predicts respective thicknesses of disc of 21.59 and 52.25 mm respectively.

A two dimensional computer model (Disperse) for modelling dispersion curves and mode shapes on plates or rods of infinite length shows an axially symmetric mode L (0, 1) with phase velocity 4214 ms⁻¹ and displacement minimum at the circumference of the disc and a non-axially symmetric bending mode F (1, 1) with phase velocity 2770 ms⁻¹ and axial displacement minimum at the centre of the disc.

The disc thickness for these two modes is calculated to be 52.67 mm and 34.62 mm respectively on the assumption that resonance occurs when the length of the rod is equal to an integer number multiple of the half wavelength of sound in the rod.

The behaviour of dry silica gel crystals (Aldrich, Davisil grade 646, ˜400 μm diameter) on discs of thicknesses about 21.59 mm, 34.62 mm and 51.26 mm in the open structure device driven at a frequency of about 40 kHz was recorded using a camcorder (DCR-TRV240E, Sony).

For a 21.58 mm thick disc the observed mode was not in agreement with the circular modes required by equation but was linear (particles clump in lines at 39.47 and 39.15 Hz).

However, the observed mode was in good agreement with computer modelling of a disc driven at the centre of one face by finite element (FE) analysis (Abaqus 6.5-1, Simulia, USA). The axial surface displacement predicted by the model shows similar nodal lines at 39.14 Hz and 39.15 Hz.

For a 34.55 mm thick disc, the observed mode was not in agreement with the circumferential mode F (1, 1) predicted by Disperse but instead resembled a six-point star at 39.84 Hz. However the observed mode was very similar to the Abaqus prediction of a star shaped axial displacement mode at 39.83 Hz.

For a 52.26 mm thick disc, particles are observed to collect in circles on the surface (see FIGS. 2 B1 and B2) which correspond to circular displacement nodes (see FIG. 2 A1, □=area of minimum displacement; nodal line at ⅔ of the radius of the disc at 40.03 Hz) and A2; □=area of minimum displacement; nodal line at the perimeter of the disc at 40.7 kHz).

The mode producing the circular node at ⅔ the radius of the disc corresponds to mode λ₀₁ of Equation (1) but is not predicted by that equation at this thickness. The perimeter mode does, however, agree with the L (0, 1) mode predicted by Disperse.

These results show the reliability of non-linear finite element analysis for determining thickness of flexible plate for acoustic resonance in desired modes.

### Acoustic Streaming

The behaviour of silica gel particles and a thin layer (1 mm to 2 mm) of water or water containing glass beads was studied in the open and closed structure devices at a frequency of about 40 kHz for an aluminium disc of thickness 51.26 mm. In the open structure device, the layer of water (containing some detergent) is shifted in the opposite direction to particles on the vibrating disc and forms heaps within 2 seconds at displacement anti-nodes (see FIGS. 2, C1 and C2). The water returns to a level layer within a similar time period when the sound wave is discontinued.

A similar layer of water containing glass beads is shifted in the same way—with the beads forming a tight clump at the centre of each heap (see FIGS. 2, E2).

In the closed structure some of the silica gel particles levitate and form plate-like clumps at the pressure nodal plane halfway between the disc and reflector. The particles move directly to the clumping position but a dynamic equilibrium between levitating particles and non-levitating particles is observed with the highest rate of exchange at a frequency of 40.7 Hz.

When viewed from above (see FIGS. 2, C, D1 and D2) it is clear that in the closed structure the distribution of particles in the nodal plane is fundamentally related to the acoustic mode of vibration of the disc and that the particles always levitate (at displacement anti-nodes) away from those areas in which they are distributed by Chladni Figures.

The size of the clumps is observed to be generally stable and not affected by the power of the sound wave or by the type of particle.

The behaviour of the particles, beads and water in these systems can only be explained by acoustic streaming of air or water.

Acoustic streaming in air was observed by introducing a thin layer of acetone (1 to 2 mm) to a closed structure device driven at a higher power level (˜50W).

The aerosol of acetone showed four circuitous streams arranged around a central circular area. The stream which resembles the petals of a flower is consistent with the observed position of levitated particle clumps (see FIGS. 2, D1).

The acoustic streaming is believed to comprise Rayleigh streaming and the clumping can be explained by the fact that the streaming directs the movement of levitated particles which are otherwise free to move within the nodal plane to points at which there is no streaming vector in that plane where they remain by the action of acoustic radiation forces.

These results strongly suggest that the location of particles in fluid samples can be directed by acoustic streaming driven by predetermined mode of acoustic vibration of a flexible plate.

### Tracking of Acoustic Modes

An Abaqus study was undertaken to track the frequency necessary to excite certain modes of acoustic vibration in an aluminium plate of diameter 70 mm with varying thickness.

Seven disc thicknesses were chosen (10 mm, 21.58 mm, 34.55 mm, 40 mm, 52.26 mm, 70 mm and 120 mm) and a search was undertaken for all circular modes found in the frequency range 10 kHz to 80 kHz.

Four modes A to D were visually identified by Abaqus (see FIG. 3, upper row A and B 10 mm; C and D 34.55 mm; lower row A to D 120 mm) and confirmed as such by calculations for end displacement in the axial direction (see FIGS. 4, A1 to D1). Modes A to C show very similar displacements from the thickest to thinnest disc but mode D shows significant changes. Modes A and C have circular displacement nodes part-way across the face of the disc whereas modes B and D have nodes at the periphery of the disc—except in the thickest discs, when the whole of the disc is moving.

The mode matching was further confirmed by calculations for side displacement in the radial direction—i.e. on a line from the edge of one face to the edge of the other face (see FIGS. 4, A2 to D2). These displacements clearly show the change in mode shape in the side of the disc with increasing disc thickness. For mode B the mode displacement direction changes from radial to axial with increasing disc thickness.

A plot of the frequency of each mode against disc thickness (see FIG. 5; □ mode A mode B; ▴ mode C; ∘ mode D) enables quick and precise reckoning of a thickness necessary to excite one or other mode in the 70 mm diameter aluminium disc at a desired frequency.

As may be seen from FIG. 5, the modes responsible for movement of the particles shown in FIGS. 2, B1 and B2 are modes A and B respectively.

An attempt was made to relate modes A to D to modes predicted by Disperse or by equation because tracking modes by finite element analysis can be laborious and is slower than for two dimensional models.

The phase velocities of the disc along the thickness direction vₚᵤ are calculated from the Abaqus prediction of resonant frequency f and disc thickness t by Equation (2) on the assumption that resonance only occurs when the thickness of the disc is an integer number multiple of the half wavelength of the sound wave in the disc.

vₚᵤ=2tf (2)

The calculated velocities are plotted together with the Disperse predictions for a 70 mm diameter aluminium rod (see FIG. 6, continuous line □ for mode B, ▪ for mode D; dashed line, ▪ for mode A, □ for mode C)). As may be seen, the calculated phase velocities for a given frequency are not always in agreement with those of the Disperse model.

The values for modes A and C are not in agreement with those of the Disperse model at any frequency while those for mode B agree with mode L (1, 0) of the Disperse model to 45 Hz (disc thickness 40 mm). The values for mode D are found to correspond to the second harmonic of the same mode L (0, 1) at frequencies up to 58 Hz (disc thicknesses above 40 mm).

The Disperse model also predicts the same axial displacement from the centre to the edge of the rod for mode L (1, 0) as is seen in the Abaqus calculations of displacements of the side of the disc in modes B and D (see FIG. 4).

These results show that the assumption underlying the correlation between modes A to D and the Disperse phase velocities is not easily confirmed because the number of wavelengths in the thickness direction in these modes is not always an integer number of the half wavelengths of the sound wave in the disc.

However, a good approximation of the number of axial wavelengths at the resonance frequency f of each mode N_{λ} can be found from the Disperse phase velocities vₚ and the thicknesses t of the disc is given by Equation (3).

N_{λ}=tflvₚ (3)

The calculated values for modes B and D are in good agreement with the displacement wavelengths shown in FIG. 4.

For mode A, which occurs below 30 kHz, the best agreement between the calculated values and the displacement wavelength is obtained for Disperse phase velocities of mode F (1, 1). For mode C the best agreement is obtained for Disperse phase velocities of mode F (1, 2).

However, the apparent fit of modes A and C must be discounted in this case because they are not consistent with a displacement node at the centre of a vibrating disc.

A plot of the calculated values against thickness of disc (see FIG. 7; continuous line ▪ for mode D, □ for mode B; dashed line ▪ for mode A, □ for mode C) shows the relationship between number of wavelengths and disc thickness is unique for each mode.

Referring now to FIG. 5, a plot of mode λ_{0,1} described by Equation (1) shows agreement with mode A for disc thicknesses up to 10 mm.

These results suggest that the Disperse model can be used for determining thickness of a flexible plate appropriate for its vibration in a predetermined acoustic mode provided that the relationship between thickness and wavelength is known or can be approximated for that mode.

### Multiple Acoustic Potential Wells

FIG. 8 shows acoustic modes of vibration in a rectangular aluminium plate (120 mm by 80 mm) of thickness 10 mm. As may be seen, multiple acoustic potential wells are obtained when the plate is driven by a stepped horn (˜40 kHz) attached by a grub screw at a central position 20 mm from the longest longitudinal edge.

The central column shows the collection of silica gel powder and the right hand column the collection of liquid (water) heaps at 40.35 kHz and 40.20 kHz (one central distorted by grub screw).

The experimental results are in good agreement with the calculated (Abaqus; plate driven at central position 26.7 mm from the longest longitudinal edge) modes of vibration at 39.89 kHz and 39.74 kHz shown in the left hand column—the latter frequency displacement maxima occurring at different stages of the vibration.

These results show acoustic modes of vibration defining a) six and b) four acoustic potential wells can be reliably obtained and without difficulty. The four-well mode is of particular interest because it defines linear boundary nodes suggesting positions for fixing walls for the closed device.

### Ninety-Six Acoustic Potential Well Plate

Although the present studies show an aluminium disc or plate on which particles can be located by an acoustic mode of vibration defining a single (centre), or a few, acoustic potential wells, it will be appreciated that it is equally possible to produce acoustic modes of vibration in rectangular plates which define any desired number of acoustic potential wells.

FIG. 9 shows a three dimensional graph resulting from Abaqus modelling of the resonant vibration of an aluminium plate of length 105 mm, width 70 mm and thickness 10 mm at a frequency of about 200 kHz.

As may be seen the crests and troughs of the acoustic mode together define ninety-six acoustic potential wells 17.

Referring now to FIG. 10, device according to one embodiment of the present invention (chamber) comprises a wall 18 in which a glass plate 19 of length 105 mm, width 70 mm and thickness 10 mm is sealed by a rubber gasket (not shown) within a hollow metal skirting plate 20. The skirting plate 20 defines an array (12×8) of circular inlet and outlet apertures 21, 22 adjacent and along its longitudinal and lateral inside edges and is associated with a pump arrangement (not shown) for pumping twenty reagent solutions across the glass plate 19 (side to side; top to bottom).

The outside edges of the skirting plate 20 are recessed along a major portion of each side thereof so that together with the side walls of the device (chamber not shown) they define two inlet and two outlet apertures 23, 24 for introduction and removal of a substrate suspension or carrier solution by the pump arrangement.

### High Throughput Analysis

Referring now to FIG. 11, the device may be used for high throughput screening of antibiotic drug candidates in the following manner.

A suspension of cells in aqueous buffer is introduced into the chamber device having floor wall 18 via the pump arrangement at an appropriate flow rate for passage between apertures 23 and 24 at about 6 cm s⁻¹. The sound is switched to ON so that the cells are located in clumps to ninety-six discrete positions on the glass plate 18.

The sound level is adjusted and suspensions of eight concentrations of bacteria (pathogenic to the clumped cells) in aqueous buffer are introduced to the chamber via apertures 21 and the pump arrangement at pump rates providing for laminar flow of each suspension across the glass plate 18 without mixing (A; side to side).

After a suitable time period, a solution of twelve concentrations of antibiotic drug candidate is introduced to the chamber via apertures 21 and the pump arrangement at pump rates providing for laminar flow of each drug solution without mixing across the glass plate 18 (B; bottom to top).

After a further period, a staining solution for indicating dead cells is introduced to the chamber via apertures 23 and the pump arrangement at a suitable flow rate. After an additional period, a wash solution of aqueous buffer is similarly introduced to the chamber and the glass plate 18 is illuminated for counting of dead cells by a light detector (in situ).

As may be determined, a detector result showing that twenty-one clumped cells are killed can indicate that three concentrations of bacteria adhere to the cells and five concentrations of the antibiotic drug candidate kill the bacteria.

1. An acoustic device for manipulation of fluid samples and/or particles in fluid samples, comprises comprising a flexible member, a sound wave generator for generating a sound wave and a sound wave coupler for coupling the sound wave from the generator into the flexible member, in which the device, the flexible member and the coupler are adapted to excite a predetermined acoustic mode of pure resonant vibration in the flexible member at a predetermined frequency of the sound wave.

2. A device according to claim 1, in which the sound coupler comprises a stepped horn mechanically fixed to the flexible member at a predetermined position on the flexible member.

3. A device according to claim 1, further comprising a reflector plate provided opposite the flexible member at a separation distance there between equivalent to about an integer multiple of half the wavelength of the sound wave in the fluid sample.

4. A device according to claim 1, in which the flexible member comprises a flexible plate.

5. A device according to claim 4, further comprising a skirting plate in sealing contact with the flexible plate which skirting plate defines a plurality of substrate and/or reagent inlets and outlets at predetermined positions on a longitudinal surface thereof.

6. A device according to claim 4, in which the flexible plate is rectangular in shape.

7. A device according to claim 6, in which the flexible plate has length about 105 mm, width about 70 mm and thickness between about 1 mm to about 100 mm.

8. A device according to claim 7, in which the predetermined frequency is between about 40 kHz and about 10 MHz whereby to provide a predetermined mode of acoustic vibration in the flexible plate which defines ninety-six (96) acoustic potential wells therewith.

9. A device according to claim 2, in which the predetermined position at which the sound coupler is fixed on the flexible member corresponds to a displacement anti-node in the predetermined acoustic mode of vibration of the flexible member.

10. A device according to claim 4, in which the flexible plate is transparent.

11. A device according to claim 10, in which the flexible plate comprises a plastics material or glass.

12. A device according to claim 4, in which the flexible plate comprises a metal.

13. A transparent, rectangular, flexible plate for use in an acoustic device according to claim 1, comprising length about 105 mm, width about 70 mm and thickness between about 1 mm to about 100 mm whereby to provide a substantially pure acoustic mode of resonant vibration on exposure to a sound wave of predetermined frequency between 40 kHz and 10 MHz at a predetermined position thereon which mode defines a plurality of acoustic potential wells therewith.

14. Use of the device according Claim 1, for high throughput analytical methods.

15. Use of the device according to Claim 1, for filtration or fluid mixing.

16. (canceled)

17. (canceled)

18. (canceled)
